(19) United States
(12) Patent Application Publication
(10) Pub. No.: US 2022/0196049 A1
(43) Pub. Date: Jun. 23, 2022

(54) DEVICE FOR COMPENSATING FOR TOLERANCES BETWEEN A FIRST COMPONENT AND A SECOND COMPONENT, AND ARRANGEMENT FOR COMPENSATING FOR TOLERANCES

(71) Applicant: WITTE Automotive GmbH, Velbert (DE)

(72) Inventors: Jan Christian BENTE, Sprockhoevel (DE); Philip WEINBERGER, Essen (DE); Harry PURWIN, Ratingen (DE)

(73) Assignee: WITTE Automotive GmbH, Velbert (DE)

(21) Appl. No.: 17/644,345

(22) Filed: Dec. 15, 2021

(30) Foreign Application Priority Data
Dec. 18, 2020 (DE) 10 2020 216 324.3

(51) Int. Cl. F16B 5/02

(52) U.S. Cl. CPC F16B 5/0233; F16B 5/0283; F16B 5/025

(57) ABSTRACT

A device for compensating for tolerances between two components to be interconnected may have a hollow-cylindrical compensating element connected with a hollow-cylindrical base element. The device may also have a threaded element for screwing together with a screw element that extends through an inner cavity of the base element and an inner cavity of the compensating element. The device may also have a driving element which is arranged in the inner cavity of the compensating element and is in frictional engagement with the screw element passing through the cavities, such that a torque exerted by the screw element can be transmitted to the compensating element. The threaded element for screwing together with the screw element is formed in the inner cavity of the compensating element as an inner thread. An arrangement for compensating for tolerances between two components to be interconnected is also described.

### FIELD

The invention relates to a device for compensating for tolerances between two components to be interconnected according to the claims. The invention also relates to an arrangement for compensating for tolerances according to the claims.

### BACKGROUND

Such a device is known in principle and is used, for example, in vehicle construction, in particular when two components are intended to be screwed together via a joint gap which is subject to tolerances. For this purpose, the device is placed between the components to be connected, and a screw element for screwing the components together, for example a screw or threaded bolt, is passed through correspondingly provided openings in the components and through the device. When the screw element is screwed, the compensating element is rotated relative to the base element by means of a driving spring connected between the screw element and the compensating element, and is thus moved from its starting position axially with respect to the base element, e.g., it is moved out of the base element, until it reaches its compensating position, in which the base element and the compensating element each abut one of the components and thus bridge the joint gap.

DE 10 2018 201 496 A1 discloses a device for compensating for tolerances between two components to be interconnected, the device comprising a hollow-cylindrical base element, a hollow-cylindrical compensating element which is in threaded engagement with the base element and can be moved from a starting position into a compensating position by means of rotation relative to the base element, a threaded element for screwing together with a screw element that extends through an inner cavity of the compensating element, and a driving element which is arranged in the inner cavity of the compensating element, is injection-molded onto a lateral surface of the inner cavity of the compensating element and is in frictional engagement with the screw element passing through cavities, such that a torque exerted by the screw element can be transmitted to the compensating element.

### SUMMARY

The object of the present invention is to provide a device which is improved compared with the prior art and is intended for compensating for tolerances between two components to be interconnected, and an arrangement for compensating for tolerances.

The object is achieved according to the invention by a device which has the features specified in the claims and by an arrangement which has the features specified in the claims.

The dependent claims relate to advantageous embodiments of the invention.

A device for compensating for tolerances between two components to be interconnected comprises a hollow-cylindrical base element, a hollow-cylindrical compensating element which is in threaded engagement with the base element and can be moved from a starting position into a compensating position by means of rotation relative to the base element, a threaded element for screwing together with a screw element that extends through an inner cavity of the base element and an inner cavity of the compensating element, and a driving element which is arranged in the inner cavity of the compensating element and is in frictional engagement with the screw element passing through the cavities, such that a torque exerted by the screw element can be transmitted to the compensating element. According to the invention, the threaded element for screwing together with the screw element is formed in the inner cavity of the compensating element as an inner thread.

Since the threaded element is integrated as an inner thread into the compensating element, what is referred to as a snap nut, which is known from the prior art and comprises a nut element as a separate threaded element, is not required for screwing together with the screw element, and therefore the number of components of the device is reduced. Also, what is referred to as a press-in nut, weld nut and/or a threaded extruded hole and/or further elements having threaded designs is/are not required in one of the components to be fastened to one another.

The threaded element is formed in the compensating element as an inner thread, as a result of which the installation space required for arranging the device, in particular on a first component, can also have smaller dimensions.

In one embodiment of the method, the inner thread is formed in a region of the compensating element adjoining the driving element, such that the screw element, for example a screw or a threaded bolt, is in frictional engagement with the compensating element in order to transmit the torque, exerted by the screw element, to the compensating element, as a result of which the compensating element moves upward out of the base element along a central longitudinal axis. The screw element is therefore fixed, by means of the driving element, in the cavity of the compensating element by means of frictional engagement.

In a development, the driving element is designed as a spring element comprising at least one spring arm, the at least one spring arm extending from a fixed end to a free end in the cavity of the compensating element such that a cross section of a free space delimited at least in portions by the at least one spring arm and provided for the passage of the screw element decreases from the fixed end to the free end.

Such a design of the driving element allows particularly efficient transmission of the torque from the screw element to the compensating element. At the same time, due to the decrease in the free space from the fixed end to the free end, the screw element can be inserted into the driving element or the compensating element particularly easily and without the risk of damaging the driving element. Furthermore, such a design of the driving element leads to the advantage that the driving element can be scaled more easily to different sizes and, in particular, can be designed to be more compact.

In a further possible embodiment of the device, a plurality of and preferably at least three spring arms are arranged around a central longitudinal axis of the driving element and are interconnected at their fixed ends by means of a connecting ring. This allows particularly uniform distribution and generation of a friction force between the screw element and the driving element.

For example, in order to reliably generate a spring action and thus the friction force between the screw element and the driving element, the driving element is formed from a thermoplastic plastics material and is elastically deformable in the rigid state.

In an alternative or additional embodiment, at least two opposing spring arms are formed in the cavity of the compensating element in the region of an insertion opening for the screw element. In this embodiment, the screw element is already in frictional engagement with the driving element in the region of the insertion opening and is fixed by means of said driving element such that a torque exerted by the screw element can be transmitted to the compensating element.

In one possible embodiment of the driving element, said driving element is formed by means of at least two opposing spring arms which protrude from a lower end of the compensating element and the spacing of which decreases toward a free end. This decreases the spacing, the free ends of the opposing spring arms having a spacing from one another which is smaller than a diameter of the screw element. If the screw element is arranged in the region of the driving element, i.e., between the two ends of the spring arms, the screw element is in frictional engagement with the compensating element such that the screw element is fixed by means of the driving element.

In a further embodiment, the driving element is formed in one piece with the compensating element such that the number of components of the device can again be reduced and thus the driving element can largely be prevented from becoming unintentionally detached from the compensating element and lost.

In one possible embodiment, the driving element is integrated as a threaded portion into the inner thread of the compensating element such that an arrangement or design of a spring element having one spring arm or a plurality of spring arms is not necessary.

In a further possible embodiment, the threaded portion, as the driving element, is provided with a coating in order to generate a predetermined thread friction torque, is designed as a clamping thread, is designed as a tapering thread, and/or the threaded portion has marks and/or deformations. By means of the driving element in the form of the threaded portion, in this case, too, the screw element is in frictional engagement with the driving element such that the torque of the screw element can be transmitted to the compensating element via the driving element, and the compensating element is thus moved out of the base element to compensate for the tolerance between the components.

In one possible embodiment, the driving element is formed annularly from at least one plastics material, an inner diameter of the driving element being smaller than a diameter of the screw element and/or the driving element being elastically deformable by a specified distance. Since the driving element is formed from a plastics material and is annular, it is possible to cut thread grooves into the driving element by means of the screw element, the screw element being in frictional engagement with the driving element and the torque of the screw element being transmitted to the compensating element via the driving element.

Alternatively or additionally, the driving element is elastically deformable by a specified distance such that it yields at least in portions when the screw element is inserted into the compensating element, and the screw element is thus in frictional engagement with the driving element, and said driving element fixes the screw element such that a torque exerted by the screw element can be transferred to the compensating element.

In addition, the device comprises a securing arrangement for securing the compensating element against movement relative to the base element. The securing arrangement forms a transport securing means for the device in order to largely prevent unintentional movement of the compensating element relative to the base element while the device is being transported, for example to its installation location, which movement in the worst case can lead to a separation of the compensating element and the base element.

The invention also relates to an arrangement for compensating for tolerances between two components to be interconnected, the arrangement comprising a device for compensating for tolerances between two components to be interconnected, and a hollow-cylindrical base element which either can be a separate part or is integrated into one of the two components.

### DESCRIPTION OF THE FIGURES

Embodiments of the invention are explained in greater detail with reference to drawings, in which:

FIG. 1 schematically shows a plan view of a compensating element of a device for compensating for tolerances between two components to be interconnected;

FIG. 2 schematically shows a sectional view of the compensating element;

FIG. 3 schematically shows a perspective view of the compensating element;

FIG. 4 schematically shows a perspective view of the compensating element with a transport securing means;

FIG. 5 schematically shows a sectional view of a base element mounted on a first component together with the compensating element;

FIG. 6 schematically shows a sectional view of the base element mounted on the first component together with the compensating element, and a screw element which passes through a second component and is inserted into the compensating element;

FIG. 7 schematically shows the compensating element, moved out of the base element by means of the screw element, in its compensating position;

FIG. 8 schematically shows an alternative embodiment of the base element;

FIG. 9 schematically shows a sectional view of the compensating element with a spring element as a driving element;

FIG. 10 schematically shows a sectional view of the compensating element with thread grooves as the driving element;

FIG. 11 schematically shows a sectional view of the compensating element with a driving element integrated into an inner thread;

FIG. 12 schematically shows a sectional view of the compensating element with two opposing spring arms as the driving element, which arms protrude from a lower end of the compensating element; and

FIG. 13 schematically shows a sectional view of the compensating element with two opposing spring arms as the driving element in the region of an insertion opening for the screw element.

### DETAILED DESCRIPTION

Parts corresponding to one another are provided with the same reference signs in all figures.

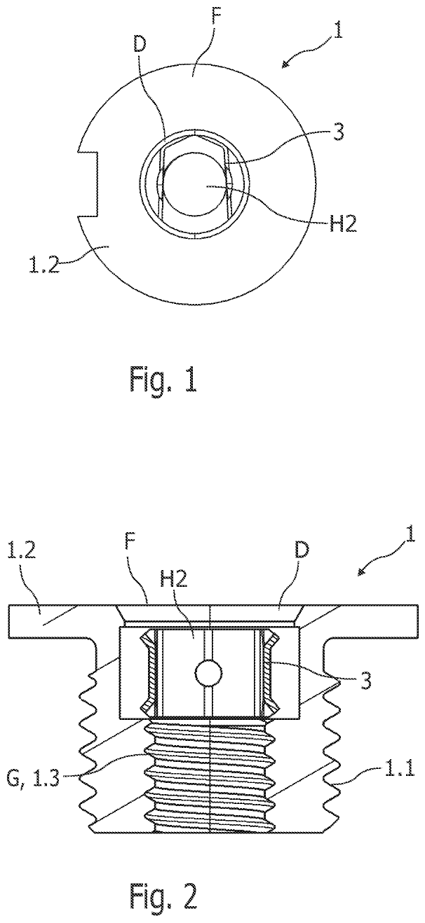

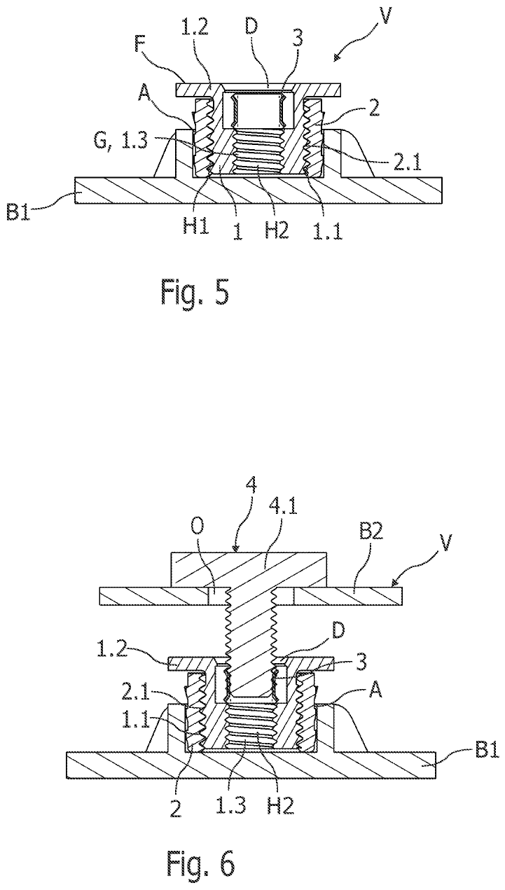

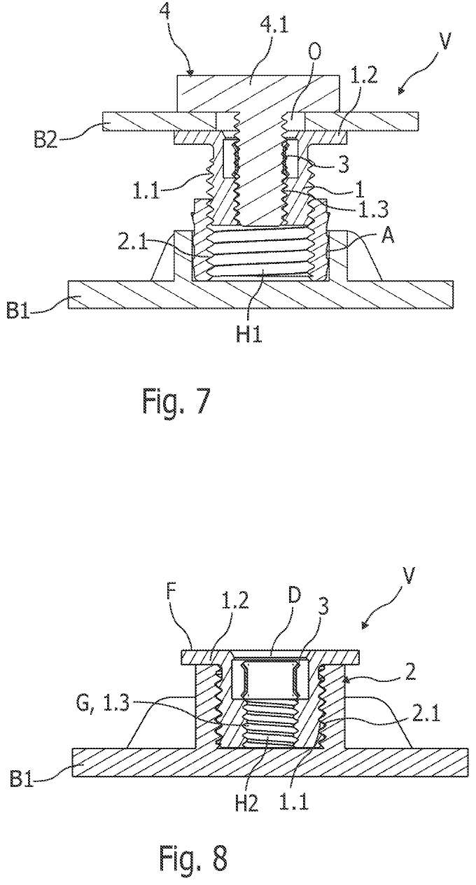

FIG. 1 is a plan view of a compensating element 1 of a device V (shown in more detail in FIGS. 5 to 7) for compensating for tolerances between the two components B1, B2 to be interconnected, a first component B1 being shown in FIGS. 5 to 7 and a second component B2 being shown in FIGS. 6 and 7.

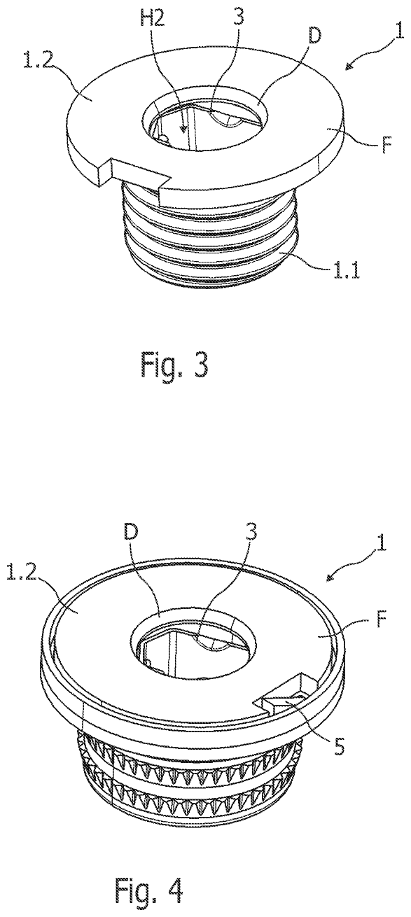

A sectional view of the compensating element 1 is shown in FIG. 2 and a perspective view of the compensating element 1 is shown in FIG. 3.

The compensating element 1 has, on its outside, an outer thread 1.1, which engages with an inner thread 2.1 of a base element 2 shown in FIGS. 5 to 7. The compensating element 1 can be moved relative to the base element 2 along a central longitudinal axis by means of rotation, i.e., can be screwed out of or into a cavity H1 of the base element 2.

A driving element 3 designed as a driving spring and formed from spring steel is arranged in an inner cavity H2 of the compensating element 1, which driving element is supported on the lateral surface of the cavity H2 of the compensating element 1 and is in frictional engagement with a screw element 4 (shown in FIGS. 6 and 7) passing through the device V, i.e., through the cavities of the base element 2 and the driving element 3, in order to transmit a torque, exerted by the screw element 4, to the compensating element 1. The screw element 4 can be designed as a screw or a threaded bolt.

On its top, the compensating element 1 has an abutment portion 1.2, which is used to support the device V against the second component B2. For this purpose, the abutment portion 1.2 has a flat abutment surface F which extends perpendicularly to the central longitudinal axis, the abutment portion 1.2 also having a central passage D for the screw element 4.

In order to reduce the number of components B1, B2 of the device V in comparison with the prior art, the compensating element 1 has a threaded element G for screwing together with the screwing element 4, which threaded element is formed in the inner cavity H2 of the compensating element 1 as an inner thread 1.3.

The fact that the threaded element G is integrated into the compensating element 1 reduces the installation space required by the device V, since what is referred to as a snap nut, which includes an additional nut element as the threaded element G, is not required.

In order to be able to rule out as far as possible that the compensating element 1 is inadvertently detached from the base element 2, a securing arrangement 5 is provided, which is designed as a transport securing means and is shown by way of example in FIG. 4.

By means of the securing arrangement 5, the compensating element 1 is secured against movement relative to the base element 2 in order to prevent unintentional movement of the compensating element 1 relative to the base element 2 while the device V is being transported.

FIGS. 5 to 7 show a sectional view of the device V when it is in use.

FIG. 5 shows the compensating element 1 screwed substantially completely into the base element 2, such a position of the compensating element 1 being its starting position.

The base element 2 is arranged in a receiving unit A of the first component B1, the base element 2 being joined, for example pressed, glued, clipped, etc., into the receiving unit A, as what is referred to as the customer interface.

When using the device V for screwing the two components B1, B2 together, the device V is arranged between said components and the screw element 4 is passed through from above through an opening O in the second component B2, through the device V, i.e., the passage D and the cavities H1, H2, as shown in FIG. 6. In the process, the screw element 4 comes into frictional engagement with the driving element 3, which is arranged in the compensating element 1, such that the screw element 4 is substantially fixed in position in the compensating element 1.

If the screw element 4 for screwing the components B1 and B2 together is rotated, for example to the right, a torque is transmitted to the compensating element 1 by means of the driving element 3, which torque causes a rotation of the compensating element 1 relative to the base element 2, as a result of which the compensating element 1 moves upward out of the base element 2 along the central longitudinal axis.

During the assembly of the device V and the transmission of the torque from the screw element 4 to the compensating element 1, said compensating element is rotated such that the securing arrangement 5 allows the compensating element 1 to move out of the base element 2 while overcoming a specified securing torque. The specified securing torque is smaller than the torque that can be transmitted from the screw element 4 to the compensating element 1 via the driving element 3. A securing element (not shown in more detail) of the securing arrangement 5 forms an end stop for the compensating element 1.

When the compensating element 1 has moved so far out of the base element 2 that the abutment surface F of the abutment portion 1.2 abuts the second component B2, a friction torque between the second component B2 and the contact surface F exceeds the torque that can be transmitted by the driving element 3, and the compensating element 1 is no longer rotated out of the base element 2. The compensating element 1 has thus assumed a position referred to as the compensating position, as shown in FIG. 7. In the compensating position of the compensating element 1, in which the base element 2 abuts the first component B1 and the abutment surface F of the compensating element 1 abuts the second component B2, the device V bridges a joint gap between the two components B1, B2, which joint gap is subject to tolerances. In order to fasten the second component B2 to the first component B1, the screw element 4 is now turned further such that a thread of the screw element 4 is in threaded engagement with the inner thread 1.3 of the compensating element 1 and the second component B2 rests, in a form-fitting manner, at least in portions, between the abutment portion 1.2 and a screw head 4.1 of the screw element 4.

In an alternative embodiment shown in FIG. 8, the base element 2 is formed on the first component B1 itself such that the first component B1 and the base element 2 are formed in one piece. In this embodiment, the base element 2 is therefore integrated into the first component B1.

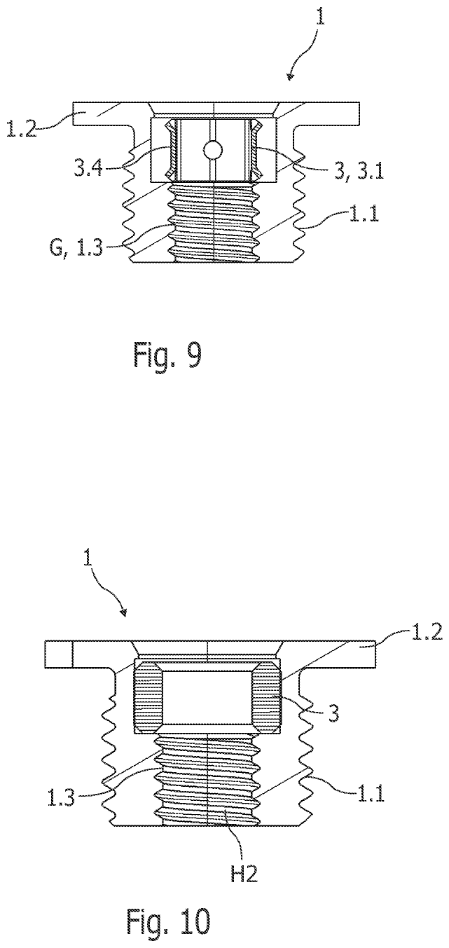

FIG. 9 shows a sectional view of the compensating element 1 with the driving element 3 which is designed as a spring element 3.1 in the form of a driving spring and is formed from spring steel.

The spring element 3.1, as the driving element 3, is U-shaped and has two spring arms 3.4, between which the screw element 4 introduced into the compensating element 1 is in frictional engagement, such that the torque exerted by the screw element 4 is transmitted to the compensating element 1, which is thus moved out of the base element 2. In their starting position, the spring arms 3.4 have no preload and have a spacing from one another which is smaller than a diameter of the screw element 4. In this case, the driving element 3, designed as the spring element 3.1, is arranged above the inner thread 1.3, in portions in the region of the abutment portion 1.2 of the compensating element 1 in the cavity H2.

FIG. 10 shows a further possible embodiment of the driving element 3, which is formed from at least one plastics material, the driving element 3 being annular. An inner diameter of the driving element 3 is selected to be smaller than a diameter of the screw element 4. In particular, the driving element 3 also extends above the inner thread 1.3 and in portions in the region of the abutment portion 1.2 of the compensating element 1.

If the screw element 4 is inserted through the passage D into the cavity H2, a thread of the screw element 4 cuts into the driving element 3 such that thread grooves are formed, a torque of the screw element 4 being transmitted to the compensating element 1 and said compensating element being moved out of the base element 2.

Alternatively or additionally, the driving element 3 formed from at least one plastics material has a specified elasticity such that the driving element 3 is elastically deformed at least in portions by a predetermined distance when the screw element 4 is inserted, the screw element 4 is form-fittingly fixed in the driving element 4 and thus the torque exerted by means of the screw element 4 is transmitted to the compensating element 1. The screw element 4 generates a friction effect together with the driving element 3, which effect is transmitted to the compensating element 1.

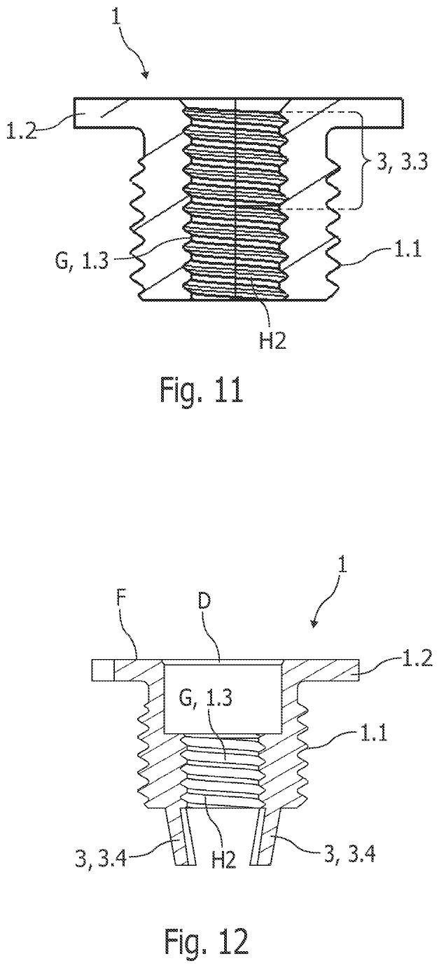

In FIG. 11, the driving element 3 is integrated as the threaded portion 3.3 into the inner thread 1.3 of the compensating element 1.

The threaded portion 3.3 can be provided with a coating, for example a plastics coating, in order to generate a specified thread friction torque.

Alternatively or additionally, the threaded portion 3.3, as the driving element 3, can be designed clampingly and/or tapering downward, a material of the screw element 4 having a higher strength than a material of the threaded portion 3.3 designed as the driving element 3.

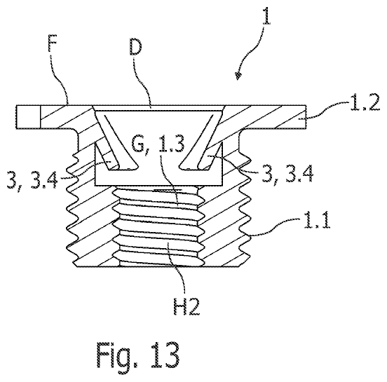

In FIGS. 12 and 13, the particular driving element 3 comprises at least two opposing spring arms 3.4.

In FIG. 12, the spring arms 3.4 protrude from a lower end of the compensating element 1, their spacing decreasing toward a free end of the spring arms 3.4. The spring arms 3.4 have a spacing from one another between the free ends which is smaller than the diameter of the screw element 4.

In FIG. 13, the spring arms 3.4, as the driving element 3, are formed on the compensating element 1 such that they protrude into the cavity H2 and are arranged above the inner thread 1.3, in portions in the region of the abutment portion 1.2.

Here, too, a spacing between the free ends of the spring arms 3.4 is smaller than the diameter of the screw element 4.

### LIST OF REFERENCE SIGNS

1 compensating element
1.1 outer thread
1.2 abutment portion
1.3 inner thread
2 base element
2.1 inner thread
3 driving element
3.1 spring element
3.3 threaded portion
3.4 spring arm
4 screw element
4.1 screw head
5 securing arrangement
A receiving unit
B1 first component
B2 second component
D passage
F abutment surface
G threaded element
H1 inner cavity of the base element
H2 inner cavity of the compensating element
O opening
V device

What is claimed is:

1.-11. (canceled)

12. A device for compensating for tolerances between two components to be interconnected, comprising:
a hollow-cylindrical compensating element which is in threaded engagement or can be brought into threaded engagement with a hollow-cylindrical base element and can be moved from a starting position into a compensating position by rotation relative to the base element,
a threaded element for screwing together with a screw element that extends through an inner cavity of the base element and an inner cavity of the compensating element and
a driving element which is arranged in the inner cavity of the compensating element and is in frictional engagement with the screw element passing through the cavities, such that a torque exerted by the screw element can be transmitted to the compensating element,
wherein the threaded element for screwing together with the screw element is formed in the inner cavity of the compensating element as an inner thread.

13. The device according to claim 12, wherein the inner thread is formed in a region of the compensating element adjoining the driving element.

14. The device according to claim 12, wherein the driving element is designed as a spring element comprising at least one spring arm, the at least one spring arm extending from a fixed end to a free end in the cavity of the compensating element such that a cross section of a free space delimited at least in portions by the at least one spring arm and provided for the passage of the screw element decreases from the fixed end to the free end.

15. The device according to claim 14, wherein the at least two opposing spring arms are formed in the cavity of the compensating element in the region of an insertion opening for the screw element.

16. The device according to claim 12, wherein the driving element is designed as at least two opposing spring arms which protrude from a lower end of the compensating element and the spacing between which decreases toward a free end, the free ends of the opposing spring arms having a spacing from one another which is smaller than a diameter of the screw element.

17. The device according to claim 12, wherein the driving element is formed in one piece with the compensating element.

18. The device according to claim 12, wherein the driving element is integrated as a threaded portion into the inner thread of the compensating element.

19. The device according to claim 18,
wherein the threaded portion, in order to generate a specified thread friction torque,
is provided with a coating,
is designed as a clamping thread,
is designed as a tapering thread,
the threaded portion has marks and/or
the threaded portion has deformations.

20. The device according to claim 12, wherein the driving element is formed annularly from at least one plastics material, an inner diameter of the driving element being smaller than a diameter of the screw element, and/or the driving element being elastically deformable by a specified distance.

21. The device according to claim 12, wherein a securing arrangement is provided for securing the compensating element against movement relative to the base element.

22. An arrangement for compensating for tolerances between two components to be interconnected, comprising the device according to claim 12 and a hollow-cylindrical base element.
